(19) United States
(12) Patent Application Publication
(10) Pub. No.: US 2009/0199927 A1
(43) Pub. Date: Aug. 13, 2009

(54) TANK ENTRY FITTING FOR USE IN A FUEL DISPENSING SYSTEM

(75) Inventors: Kristopher A. Kane, Hamilton, OH (US); James E. Kesterman, Cincinnati, OH (US)

Correspondence Address: WOOD, HERRON & EVANS, LLP, 2700 CAREW TOWER, 441 VINE STREET, CINCINNATI, OH, 45202, US

(73) Assignee: DELAWARE CAPITAL FORMATION, INC., Wilmington, DE (US)

(21) Appl. No.: 12/028,045

(22) Filed: Feb. 8, 2008

(51) Int. Cl. B65B 1/04; F16L 3/04

(52) U.S. Cl. 141/98; 285/141.1

(57) ABSTRACT

A tank entry fitting for a conduit line passing through a wall includes a housing having a first end portion, a second end portion, and a passageway for receiving the conduit line. The housing further includes a rigid portion that defines a mating surface to form a bonded joint with the wall, wherein the bonded joint forms a fluid tight seal between the housing and the wall. The entry fitting further includes a flexible coupling member having a first end portion coupled to the housing, a second end portion coupled to the conduit line, and a passageway for receiving the conduit line. The flexible coupling member forms a fluid tight seal between the housing and the conduit line. Such an entry fitting provides a rigid portion which is conducive to bonding with the wall, and a resilient portion that provides for relative movement between the conduit line and the wall.

### TECHNICAL FIELD

The present invention relates generally to entry fittings, and more particularly, to tank entry fittings for use in fuel dispensing systems.

### BACKGROUND

Fuel dispensing systems used at retail gas stations typically include an underground tank containing gasoline, diesel fuel or other liquid fuels, an above ground dispensing unit terminating in a nozzle adapted to supply the fuel to a motor vehicle, and a piping system interconnecting the underground tank and dispensing unit. The piping system includes a number of components that present potential leak sites in the piping system. While infrequent, to reduce the risks of fuel leaking into the environment, such components are typically located within a sump configured to contain the fuel therein in the event of a leak in the piping system. For example, the piping system may include a sump associated with the underground storage tank, referred to as the tank sump, and a sump associated with the dispensing unit, referred to as the dispenser sump. Typically, rigid, fluid-carrying conduit lines pass into and out of the sumps via openings or apertures in the wall of the sumps. The piping system further includes entry fittings at the location where the conduit lines pass through the wall of a sump so as to form a seal therebetween and prevent any fuel from leaking from the sump on the occasion of a leak in the piping system and collection of fuel within the sump.

A variety of entry fittings are known in the art that have been developed in response to the foregoing potential problem. While these entry fittings are generally successful for their intended purposes, manufacturers continually strive to improve such fittings to meet consumer needs as well as to satisfy various governmental regulations. By way of example, some entry fittings have a generally rigid construction so as to form a seal between the sump wall and the fluid conduit. Such rigid entry fittings, however, may not provide for relative movement between the sump and fluid conduit, which may occur due to frost heave and other environmental conditions, as is known in the art. The inability to accommodate relative movement between the sump and fluid conduit may hasten failure of the seal. Other entry fittings may have a resilient construction so as to accommodate relative movement between the sump and the fluid conduit. For example, such entry fittings are typically made of flexible materials (e.g., rubber-based materials, thermoplastics, etc.). Resilient entry fittings, however, are potentially more susceptible to ozone and fuel degradation. Additionally, such resilient entry fittings may not be conducive to bonding techniques used to form the seal between the entry fitting and the sump wall. Such bonding techniques have proven reliable and are considered desirable in the industry.

In addition to the above, many current entry fittings do not readily conform to non-planar surfaces. By way of example, some sump tanks may be generally cylindrical, thus having generally arcuate side walls through which the fluid conduit(s) extend. Because the side walls have some finite curvature, traditional entry fittings designed for generally planar walls may not sufficiently conform thereto to provide a fluid-tight seal. Various ad hoc approaches must then be used in an attempt to provide a reliable seal between the sump and entry fitting.

It is therefore desirable to provide an improved entry fitting for use in fuel dispensing systems that addresses these and other aspects of existing entry fitting designs.

### SUMMARY

To these ends, an embodiment of the invention contemplates a tank entry fitting for a fluid conduit line passing through an opening in a wall having a housing adapted to be inserted into the opening and including a first end portion, a second end portion, and a passageway extending therebetween for receiving the fluid conduit line therethrough. The housing further includes a rigid portion that defines a mating surface that forms a bonded joint with the wall, wherein the bonded joint forms a fluid tight seal between the housing and the wall. The entry fitting further includes a flexible coupling member having a first end portion coupled to the housing, a second end portion coupled to the fluid conduit line, and a passageway extending therebetween for receiving the fluid conduit line therethrough. The flexible coupling member forms a fluid tight seal between the housing and the fluid conduit line. Such an entry fitting provides a rigid portion which is conducive to bonding with the wall and a resilient portion that provides for relative movement between the conduit line and the wall.

In one embodiment, a flange projects outwardly from the housing and defines the mating surface for forming the bonded joint with the wall. In some applications, the wall may be non-planar. In such applications, at least a portion of the flange has a non-planar shape that corresponds to the shape of the wall. Such corresponding shapes facilitate bonding between the housing (e.g., flange) and the wall. The flange may be bonded to the wall on either side thereof (e.g., internal or external to a tank) and the flexible coupling member may be positioned on either side of the wall. In another embodiment, the housing includes a generally L-shaped flange projecting inwardly thereof so as to define a cavity for receiving an access or duct pipe therein.

An entry fitting that may be particularly conducive to double-walled tanks includes a first housing having a first end portion, a second end portion, and a passageway extending therebetween that receives the fluid conduit line therethrough, and a second housing including a first end portion, a second end portion, and a passageway extending therebetween that receives the fluid conduit line therethrough. The first end portion of the second housing is coupled to the second end portion of the second housing and at least one of the first or second housing includes a mating surface coupled to the wall so as to form a fluid tight seal therebetween. A first flexible fluid coupling member includes a first end portion coupled to one of the first or second housing, a second end portion coupled to the fluid conduit line, and a passageway extending therebetween that receives the fluid conduit line therethrough. The flexible coupling member forms a fluid tight seal between one of the first or second housing and the fluid conduit line.

In one embodiment, a flange projects outwardly from the first housing to define a mating surface for coupling to the wall. The mating surface may, for example, be bonded to the wall. A flange may also project outwardly from the second housing and also define a mating surface for coupling to the wall. Again, the mating surface may be bonded to the wall. At least one of these flanges may be non-planar in shape to correspond to a non-planar wall. In such an embodiment, the entry fitting may further include a second flexible coupling member including a first end portion coupled to one of the first or second housing, a second end portion coupled to the fluid conduit line, and a passageway extending therebetween that receives the fluid conduit line therethrough. In one embodiment, the first and second flexible coupling members are coupled to the same housing and are configured to define an interstitial space between the two flexible coupling members. Such an interstitial space may be achieved by including a stepped configuration in one of the housings, such as the second housing, for example, that defines a first bearing surface and a second bearing surface spaced therefrom. The first flexible coupling member may be coupled to the second housing at the first bearing surface and the second flexible coupling member may be coupled to the second housing at the second bearing surface. The second bearing surface may be spaced from the first bearing surface due to the stepped configuration of the second housing or by locating the second bearing surface on an outer flange of the second housing. One of the flexible coupling members may include an access port in fluid communication with the interstitial space for monitoring level changes, temperature, etc.

In one embodiment, a fuel dispensing system having a fluid conduit line includes a tank with at least one wall thereof defining an opening for receiving the fluid conduit line therethrough, and a tank entry fitting for forming a seal between the fluid conduit line and the tank. The tank entry fitting includes a housing inserted into the opening and having a first end portion, a second end portion, and a passageway extending therebetween for receiving the fluid conduit line therethrough. The housing further includes a rigid portion that defines a mating surface that forms a bonded joint with the wall, wherein the bonded joint forms a fluid tight seal between the housing and the wall. The entry fitting further includes a flexible coupling member having a first end portion coupled to the housing, a second end portion coupled to the conduit line, and a passageway extending therebetween for receiving the conduit line therethrough. The flexible coupling member forms a fluid tight seal between the housing and the fluid conduit line.

In another embodiment, a fluid dispensing system includes a tank having at least one wall thereof defining an opening for receiving the fluid conduit line therethrough, and a tank entry fitting for forming a seal between the fluid conduit line and the tank. The wall includes an inner shell, and outer shell, and an interstitial space therebetween. The entry fitting includes a housing inserted into the opening and having a mating surface for coupling to the wall adjacent the opening so as to form a fluid tight seal between the housing and the wall. The entry fitting further includes a pair of redundant flexible coupling members for forming a fluid tight seal between the housing and the fluid conduit line. The redundant coupling members may be configured to define an interstitial space therebetween which may be monitored for leaks.

### BRIEF DESCRIPTION OF THE DRAWINGS

These and other features, aspects and advantages of the present invention will become better understood with regard to the following description, appended claims and accompanying drawings wherein:

FIG. 1 is a schematic illustration of a fuel dispensing system that incorporates a tank entry fitting according to an embodiment of the invention;

FIG. 2 is an enlarged partial top plan view of a tank entry fitting in accordance with an embodiment of the invention in operation with a tank and a fluid conduit line;

FIG. 2A is an enlarged partial top plan view of a tank entry fitting in accordance with another embodiment of the invention in operation with a tank and a fluid conduit line;

FIG. 3 is an enlarged partial top plan view of a tank entry fitting in accordance with another embodiment of the invention in operation with a tank, a fluid conduit line, and an access or duct pipe;

FIG. 4 is an enlarged partial top plan view of a tank entry fitting in accordance with another embodiment of the invention in operation with a double-walled tank and a fluid conduit line;

FIG. 5 is an enlarged partial top plan view of a tank entry fitting in accordance with another embodiment of the invention in operation with a double-walled tank and a fluid conduit line; and

FIG. 6 is an enlarged partial top plan view of a tank entry fitting in accordance with another embodiment of the invention in operation with a double-walled tank, a fluid conduit line, and an access pipe.

### DETAILED DESCRIPTION

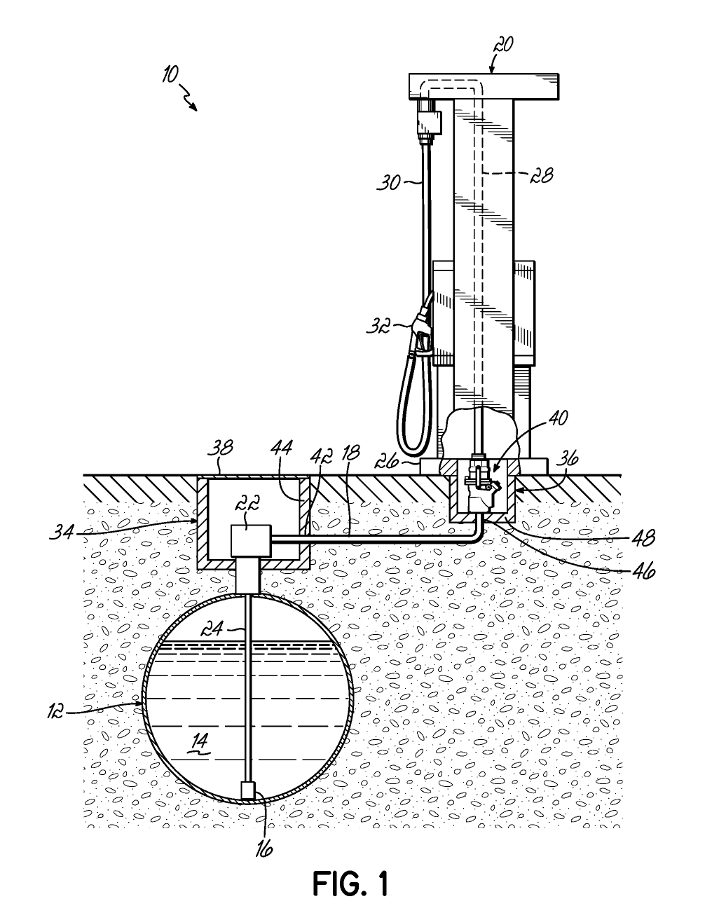

FIG. 1 is a schematic illustration of an exemplary fuel dispensing system 10 that incorporates a tank entry fitting according to an embodiment of the invention. The fuel dispensing system 10 generally includes an underground storage tank (“UST”) 12 for storing one or more types of fuel 14, a submersible pump 16 located in the storage tank 12, and one or more fluid conduit lines 18 that transport the fuel under pressure to one or more dispensing units 20. Typically, the fluid conduit line 18 is coupled to the pump 16 via a pump manifold 22 located external to storage tank 12 and a stand pipe 24 extending into the storage tank 12 and operatively coupled to the pump 16. The pump manifold 22 may include various flow control and flow measurement devices, such as check valves, leak detectors, etc. (not shown). The fluid conduit line 18 extends from the pump manifold 22 to beneath the dispensing unit 20, which is typically mounted on a pedestal 26, which may be made of concrete and which in turn may be mounted on a surface, such as, for example, a concrete surface of a retail gas station. A rigid pipe or conduit 28, in fluid communication with fluid conduit line 18, may extend upwardly through the interior of the dispensing unit 20 and be in fluid communication with a flexible hose 30 that terminates in a nozzle 32 that is adapted for dispensing fuel into the fuel tank of a motor vehicle, such as an automobile, truck, etc.

The fuel dispensing system 10 further includes a number of concealment tanks or enclosures, such as sump tanks, for example, for containing fuel on the occasion that a leak forms in the fuel dispensing line. Such concealment tanks are adapted to prevent or reduce the likelihood that any fuel will leak to the surrounding environment in the event of a leak in the fuel dispensing line. As illustrated in FIG. 1, the fuel dispensing system 10 may include a storage tank sump 34 and a dispenser sump 36. The storage tank sump 34 may contain the pump manifold 22 and associated flow control and measurement devices and may be accessible from the surface via a removable manway cover 38. The dispenser sump 36 is typically located directly beneath the dispenser 20 and contains various components, such as an emergency shutoff valve 40, for example.

As shown in FIG. 1, the fluid conduit line 18 passes through one or more walls of the sumps 34, 36. For example, fluid conduit line 18 passes through an opening 42 in side wall 44 of sump 34 and through an opening 46 in bottom wall 48 of sump 36. As those of ordinary skill in the art will recognize, the number of openings formed in the sumps 34, 36 and the particular walls through which the fluid conduit line(s) 18 extend depend on the specific application, and the invention is not limited to any particular number of openings or locations through which the fluid conduit line(s) extend. In order for the sumps 34, 36 to operate for their intended purpose of, among other things, containing leaking fuel therein, a fluid tight seal must be formed between the fluid conduit line 18 extending through the openings 42, 46 and the walls 44, 48 of the sumps 34, 36, respectively, adjacent the openings. To this end, a tank entry fitting may be used to effectuate such a seal.

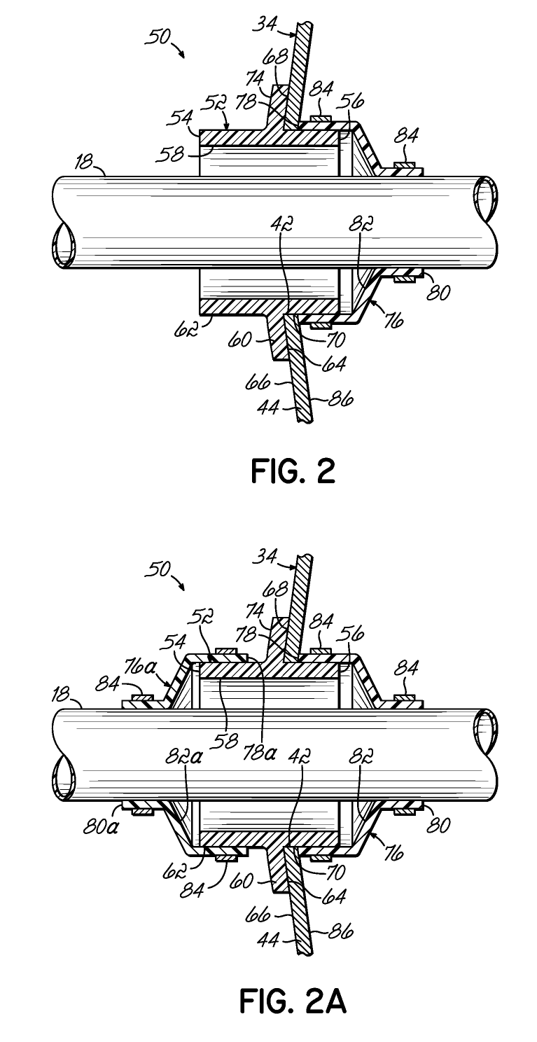

FIG. 2 illustrates an exemplary tank entry fitting 50 in accordance with one embodiment of the invention. While the tank entry fitting will be described in connection with opening 42 in the side wall 44 of sump 34, it should be recognized that the tank entry fitting 50 may also be used in other openings formed in sump 34 as well as the openings formed in sump 36, such as opening 46 in the bottom wall 48 of sump 36. Tank entry fitting 50 includes a housing 52 having a first end portion 54 adapted to be located external to the sump 34 when mounted thereto, a second end portion 56 adapted to be located internal to the sump 34 when mounted thereto, and a passageway 58 extending between the first and second end portions 54, 56. The passageway 58 receives the fluid conduit line 18 therethrough such that the fluid conduit line 18 passes through the side wall 44 from the exterior of the sump 34 to the interior of the sump 34. As explained in more detail below, the housing 52 further includes a flange 60 projecting outwardly from an outer surface 62 of the housing 52 for mating the housing 52 to the side wall 44 of the sump 34.

The housing 52 may be formed from a suitable, relatively rigid material. For example, the housing 52 may be formed from plastic, fiberglass, sheet molding compound (SMC), thermosets, thermoplastics, metal, etc. In one embodiment, the housing 52, including the flange 60, may be integrally formed from a moldable polymeric material such that the housing has a unitary structure. The invention, however, is not so limited as the flange 60 may be coupled with the housing 52 as a separate component or element through various processes including welding, adhesives, and other suitable processes. Moreover, the housing 52 may be sized and shaped so as to fit snugly within the opening 42 in side wall 44 when mounted thereto. For example, the housing 52 may be generally circular in cross-sectional shape so as to fit within a generally circular opening in a tight manner. The housing 52 and opening 42 may, however, have other corresponding cross-sectional shapes including rectangular, triangular, oval, etc.

In one embodiment, when the housing 52 is mounted to sump 34, the flange 60 may be located exterior to the sump 34 such that an inner surface 64 of the flange 60 abuts the outer surface 66 of the sump 34 and operates as a mating surface. To effectuate a seal between the housing 52 of the entry fitting 50 and the sump 34, a bonded joint 68 is formed along at least a portion of the interface between the inner surface 64 of the flange 60 and the outer surface 66 of the sump 34. The bonded joint 68 forms a fluid tight seal between the housing 52 and the sump 34 so that no fuel may escape from the sump 34 through the interface therebetween on the occasion of a leak and collection of fuel within the sump 34. Various adhesives may be used to form the bonded joint 68 including two-part (meth)acrylate compositions (e.g., Plexus®), or other suitable adhesives sufficient to provide a fluid tight seal between the housing 52 and the sump 34. In addition to the above, a bonded joint 70 may also be formed at the interface between the wall portion that defines opening 42 and the outer surface 62 of the housing 52 adjacent the flange 60.

In one aspect of the invention, at least a portion of the flange 60 may be profiled or contoured so as to substantially correspond to the shape of the side wall 44 adjacent opening 42. By way of example, sump tanks are commercially available that have either a rectangular configuration with generally planar surfaces, or a cylindrical configuration with generally arcuate surfaces (e.g., surfaces with a finite and constant radius of curvature). Thus, in one embodiment, the flange 60 has a generally planar configuration such that the inner surface 64 of the flange 60 mates with a generally planar side wall of the sump (not shown). In an alternative embodiment, however, and as illustrated in FIG. 2, the flange 60 may be configured such that the inner surface 64 thereof substantially corresponds to the generally arcuate side wall 44 of the sump 34 (e.g., sump 34 has a generally cylindrical configuration). Contouring the flange 60 to correspond to the shape of the housing wall provides enhanced bonding between the housing 52 and the sump 34.

The contouring of at least a portion of the flange 62 may be achieved in several ways. For example, the entire flange 60 may be contoured so as to substantially correspond to the shape of the sump side wall 44 adjacent the opening 42, as shown in FIG. 2. Such contouring of the flange 60 may be done, for example, during a molding operation that forms the housing 52. Alternatively, portions of the inner surface 64 of the flange 60 may be selectively configured to substantially correspond to the shape of the sump side wall 44 while, for example, an outer surface 74 of the flange 60 remains generally planar (not shown). This may be done during a molding operation as described above. Alternatively, portions of the inner surface 64 of the flange 60 may be selectively milled or otherwise removed so as to correspond to the shape of the sump side wall 44.

In one embodiment, a plethora of housings 52 may be provided having flanges 60 with inner surfaces 64 with different radii of curvature to correspond to different sized sumps 34. Once the size of the sump is determined, the appropriately sized housing may then be selected. In another embodiment, however, a housing 52 having a flange 60 with an inner surface 64 with a specific radius of curvature may be used on sumps having a size approximate to, but not necessarily equal to, that of the inner surface 64. By way of example, a housing 52 having a flange 60 shaped so as to have a radius of curvature of approximately 22.5 inches may be used on sumps having inner diameters of between approximately 42 inches and approximately 48 inches. Thus, while the shape of the inner surface 64 of the flange 60 and the side wall 44 of the sump 34 do not have to precisely match, the inner surface 64 and side wall 44 must sufficiently correspond in shape such that a suitable bonded joint 68 may be formed.

The fluid tight seal between the housing 52 and the sump 34 forms but one part of the total sealing function of the tank entry fitting 50. Additionally, a seal must also be formed between the housing 52 and the fluid conduit line 18. In this regard, the tank entry fitting 50 further includes a generally flexible coupling member, such as flexible boot 76. Flexible boot 76 includes a first end portion 78 adapted to be coupled to the second end portion 56 of the housing 52 in the interior of sump 34, a second end portion 80 adapted to be coupled to the fluid conduit line 18, and a passageway 82 extending between the first and second end portions 78, 80 and adapted to receive the fluid conduit line 18 therethrough. The first end portion 78 of boot 76 may be sized to approximately correspond to the size of the second end portion 56 of the housing 52 so as to be received thereon in a slight friction fit. Additionally, the second end portion 80 of boot 76 may be sized to approximately correspond to the size of the fluid conduit line 18. For example, the size of the second end portion 80 may be slightly smaller than fluid conduit line 18 such that the fluid conduit line 18 is tightly received therein. The first and second end portions 78, 80 of the boot 76 may be secured to the second end portion 56 of the housing 52 and fluid conduit line 18, respectively, using clamping members, such as band clamps 84.

The boot 76 may be formed from a suitable, relatively resilient material. For example, the boot 76 may be formed from elastomers, including thermoplastic polyurethane elastomers (e.g., Pellethane®), suitable natural or synthetic rubbers (e.g., nitrile rubber or Buna-N), or other suitable materials.

The tank entry fitting 50 shown and described above has several advantages over existing entry fittings. In particular, in one aspect, the tank entry fitting 50 includes a first relatively rigid portion (e.g., housing 52) that forms a first seal with the sump 34, and a second relatively flexible portion (e.g., boot 76) that forms a second seal with the fluid conduit line 18. The rigid construction of the first portion may provide advantages regarding the bonded joint 68. In this regard, the use of bonding techniques has gained significant commercial acceptance in the industry due to its perceived reliability in the field. However, the use of bonding techniques is generally limited to the coupling of relatively rigid materials, as its use with relatively flexible materials may be problematic. Thus, entry fittings primarily made of resilient materials may not make use of bonding to effectuate a seal with either the sump or the fluid conduit line. Accordingly, such resilient entry fittings may be considered unreliable in the field. As noted above, because the housing 52 is formed from a relatively rigid material, a bonding technique may be used to effectuate a seal between the housing 52 and the sump 34. In addition, some commercially available sumps are formed from fiberglass, which is highly conducive to bonding techniques. Therefore, forming the first portion of the tank entry fitting 50 from a relatively rigid material provides for the use of bonding techniques, which is not only considered desirable by the industry, but also results in a strong, reliable seal formed between the housing 52 and the sump 34.

Notwithstanding that above, the flexible construction of the second portion may also provide certain advantages. In particular, the ability of the second portion to flex enhances the coupling between the entry fitting 50 and the fluid conduit line 18. In this regard, a rigid connection between the entry fitting and the fluid conduit line 18 requires relatively precise alignment of the conduit line relative to the entry fitting. Achieving such precise alignment, however, may entail a trial-and-error approach that is time consuming and costly. Moreover, the fuel dispensing system is typically a dynamic system, not a static system. For example, for those systems that have at least a portion thereof underground (FIG. 1), ground movement, due to frost heave or other environmental conditions, for example, may cause one portion of the fuel dispensing system to move relative to another portion of the fuel dispensing system. Thus, it may not be uncommon for the fluid conduit line 18 to move relative to sump 34. Such movement may be accommodated by the flexible second portion of the tank entry fitting 50 without large stresses being imposed thereon which may otherwise crack or break more rigid entry fittings. Thus, the tank entry fitting in accordance with an aspect of the invention gains the benefits of rigid entry fitting construction without its associated drawbacks, and gains the benefits of resilient entry fitting construction without its associated drawbacks.

Another advantage provided by the tank entry fitting 50 described above is that the contouring of the entry fitting 50 at least along those portions that mate with sump 34 (e.g., inner surface 64 of flange 60 or flange 60 as a whole) so as to more closely match that contour of the sump 34 provides for an improved connection therebetween. For example, using a generally planar portion on an entry fitting to mate with a cylindrical wall of a sump may result in a connection that cannot be bonded, a connection that requires an excessive amount of adhesive, and/or a connection that is unreliable in the field. As noted above, by contouring at least a portion of the flange 60 (e.g., the mating portion) to match the contour of the sump 34, a more reliable joint, such as bonded joint 68, may be formed therebetween.

Alternative embodiments to that shown in FIG. 2 will now be described. In these embodiments, like reference numerals will refer to like features as that shown in FIG. 2. As an initial matter, FIG. 2 shows the flange 60 positioned external to the sump 34 with at least the inner surface 64 thereof contoured to match the contour of the outer surface 66 of the sump 34 (e.g., both are arcuately shaped). In an alternative embodiment, however, the flange 60 may be positioned on the inside of the sump 34 such that at least the outer surface 74 thereof is contoured to match the contour of the inner surface 86 of the sump 34 (not shown). Moreover, although the flexible boot 76 is shown as being located internal to the sump 34 in FIG. 2, the boot 76 may alternatively be located external to the sump 34.

In another embodiment, as shown in FIG. 2A, a flexible coupling member may be located both internal and external to the sump 34. Thus, in addition to boot 76, a flexible boot 76a may be disposed external to sump 34 and includes a first end portion 78a adapted to be coupled to the first end portion 54 of housing 52, a second end portion 80a adapted to be coupled to the fluid conduit line 18, and a passageway 82a extending between the first and second end portions 78a, 80a and adapted to receive fluid conduit line 18 therethrough. The first end portion 78a of boot 76a may be sized to approximately correspond to the size of the first end portion 54 of the housing 52 so as to be received thereon in a slight friction fit. Additionally, the second end portion 80a of boot 76a may be sized to approximately correspond to the size of the fluid conduit line 18. For example, the size of the second end portion 80a may be slightly smaller than fluid conduit line 18 such that the fluid conduit line 18 is tightly received therein. The first and second end portions 78a, 80a of the boot 76a may be secured to the first end portion 54 of the housing 52 and fluid conduit line 18, respectively, using clamping members, such as band clamps 84. The flexible boot 76a may be formed from the same materials as flexible boot 76 provided above.

The embodiment shown in FIG. 2A may provide additional advantages over that shown in FIG. 2. For example, the use of two flexible boots 76, 76a to provide a seal between the housing 52 and the fluid conduit line 18 provides redundant sealing that further prevents or reduces the likelihood of any fuel from being exposed to the surrounding environment on the occasion of a leak and collection of fuel within the sump 34. Thus, if, for example, flexible boot 76 (e.g., the primary seal) were to unexpectedly fail, the flexible boot 76a (e.g., the backup seal) would perform the sealing function between the housing 52 and the fluid conduit line 18 such that no fuel would escape to the environment. In addition to providing redundant seals, external flexible boot 76a also provides a protecting function for internal flexible boot 76. For example, flexible boot 76a may prevent dirt, gravel, and other debris external to sump 34 from entering housing 52 via first end portion 54 and bearing against flexible boot 76, which may weaken or otherwise compromise the (inner) seal between the housing 52 and the fluid conduit line 18. Furthermore, flexible boot 76a may further prevent or reduce the likelihood of ground water and other fluid external to sump 34 from leaking into the sump 34.

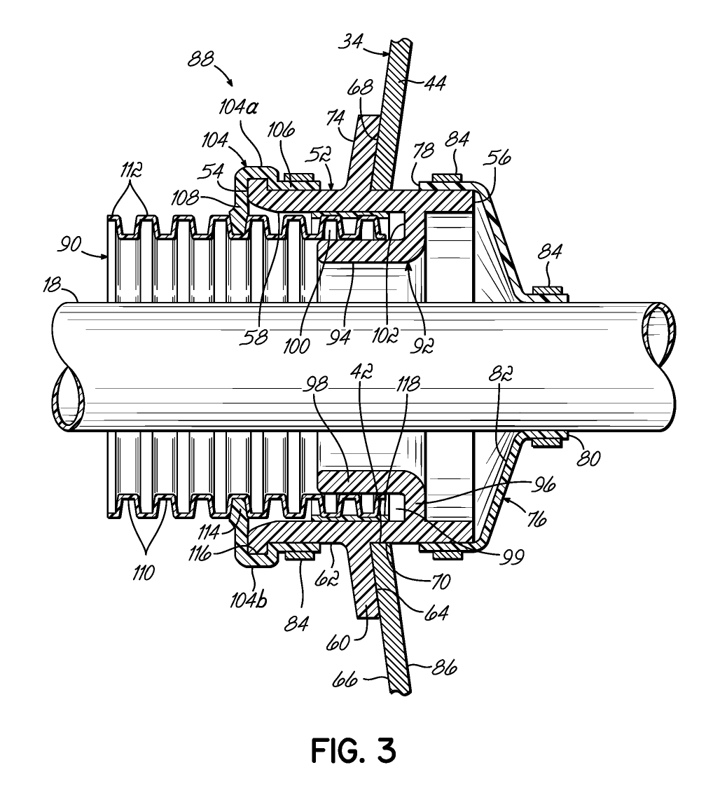

FIG. 3, in which like reference numerals refer to like features in FIG. 2, illustrates another embodiment of a tank entry fitting 88. The tank entry fitting 88 is configured to be used with access or duct pipe 90. Access or duct piping is generally well known in the industry and is coaxially disposed about fluid conduit line 18 to protect the fluid conduit line 18 from dirt, ground water, etc. The access or duct piping also allows retractability and replacement of fluid conduit line 18 in a more convenient manner. The housing 52 of entry fitting 88 is similar to that in FIG. 2 and is secured to the sump 34 in the manner described above to effectuate a seal between the housing 52 and the sump 34. Entry fitting 88 further includes flexible boot 76 internal to sump 34 with its first end portion 78 coupled to the second end portion 56 of the housing 52 and its second end portion 80 coupled to the fluid conduit line 18 in the manner as described above. The entry fitting 88 has been modified, however, to accommodate the access or duct pipe 90, which modifications will now be described.

As shown in FIG. 3, the housing 52 further includes an L-shaped flange 92 projecting generally inwardly from an inner surface 94 of the housing 52. The flange 92 includes a first leg 96 projecting away from housing 52 in a direction generally perpendicular to the portion of the housing 52 from which it extends, and a second leg 98 coupled to the first leg 96 and projecting toward the first end portion 54 (e.g., projecting externally relative to the sump 34) in a direction generally parallel to, but spaced from, the housing 52. Such a configuration results in a cavity 99 having a first opened end 100 and a second closed end 102, wherein the cavity 99 is adapted to receive an end of the access or duct pipe 90 therein. The L-shaped flange 92 may be continuous along the entire inner surface 94 of the housing 52 (e.g., an annular flange along the entire inner circumference of the housing 52), or alternatively, include a plurality of discrete portions along the inner surface 94.

The access pipe 90 may be coupled to the housing 52 via clamp 104. Clamp 104 has a multi-piece construction with, for example, an upper clamping portion 104a and a bottom clamping portion 104b (relative to the orientation shown in FIG. 3). The clamping portions 104a, 104b each include a leg 106 that abuts and overlies the outer surface 62 of housing 52 adjacent the first end portion 54 thereof. A separate clamp, such as band clamp 84, may be used to secure the clamping portions 104a, 104b to the housing 52. The clamping portions 104a, 104b further include a U-shaped portion terminating in an inwardly projecting finger 108. The fingers 108 project into one of the recesses 110 formed between adjacent outwardly extending ribs 112 of the access or duct pipe 90, the construction of which is generally known in the art. The interaction between the fingers 108 and the selected recess 110 prevents any relative movement of the access or duct pipe 90 away from or toward the housing 52. Additionally, the first end portion 54 of housing 52 may include an outwardly projecting lip 114 that is received in a recess 116 in the U-shaped portion of the clamping portions 104a, 104b. The lip 114 may be continuous along the entire outer surface 62 of the housing 52 (e.g, an annular lip along the entire outer circumference of the housing 52), or alternatively, include a plurality of discrete portions along the outer surface 62.

The entry fitting 88 may further include a sealing member 118 that forms a fluid tight seal between the access or duct pipe 90 and the housing 52 when the access or duct pipe 90 is mounted thereto. For example, as shown in FIG. 3, an outer wall of the cavity 99 (defined by a portion of the inner surface 94 of housing 52) includes sealing member 118. In this way, when the end of the access or duct pipe 90 is inserted into the cavity 99, the access or duct pipe 90 compresses the sealing member 118 such that a seal is formed between the housing 52 and one or more of the raised ribs 112 on the pipe 90. The sealing member 118 may be formed from nitrile, rubber based comp, thermoplastics, Buna-N, Viton®, or other suitable materials, and prevents or reduces the likelihood of dirt, gravel, ground water, and other matter from accessing the interior of the sump 34. While the sealing member 118 is shown coupled to the housing 52, it should be recognized that the sealing member may also be coupled to the end of the access or duct pipe 90 such that when the access or duct pipe 90 is inserted into cavity 99, a seal is formed between the access or duct pipe 90 and housing 52.

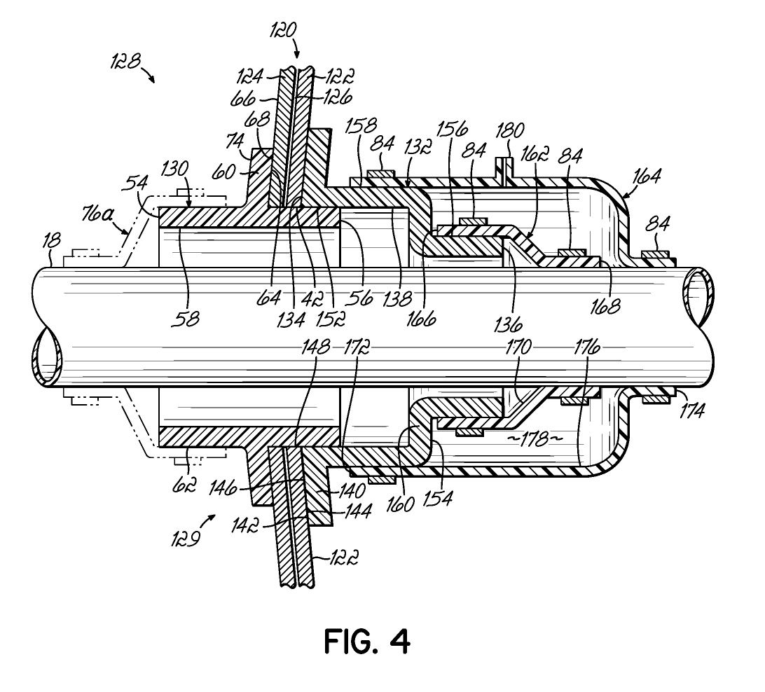

In recent years, more comprehensive federal, state and local regulations regarding the release of fuels and other hazardous materials to the environment have been imposed on the industry in an attempt to limit their impact on the surrounding environment. Some states, such as California for example, have imposed regulations that require redundancy in systems that handle hazardous materials, including fuels. The redundancy may include, for example, providing double-walled containment structures. Where such regulations exist, and as illustrated in FIG. 4, a sump 120 may, for example, have a double-walled construction including an inner shell 122, an outer shell 124, and an interstitial space 126 defined therebetween. The interstitial space 126 is typically very small and has been exaggerated in FIG. 4 for illustration purposes. The interstitial space 126 may be monitored, such as through either positive pressure or negative pressure (i.e., vacuum) monitoring. Thus, if the pressure in the interstitial space 126 changes (positively or negatively) over a specified time period, a leak may exist and the system shut down and evaluated, thereby preventing or limiting any release of the fuel to the surrounding environment. As those of ordinary skill in the art will appreciate, the interstitial space 126 may be monitored in other ways so as to detect a potential leak and is therefore not limited to leak monitoring via pressure testing.

As the entry fittings into the sumps represent potential leak sites, the regulations that require a double-walled sump may also require a tank entry fitting that provides the necessary redundancy and possibly even leak monitoring capabilities. An exemplary entry fitting in accordance with one embodiment of the invention directed to meeting or exceeding regulations in such jurisdictions is shown in FIG. 4. The tank entry fitting 128 includes a two-part housing 129 having a first housing portion 130 and a second housing portion 132. The two-part housing 129 is primarily a result of the double-walled construction of the sump 120 which requires that a seal be formed between the housing 129 and the outer shell 124 of the sump 120 (via the first housing portion 130), and a seal be formed between the housing 129 and the inner shell 122 of the sump 120 (via the second housing portion 132). Such a two-part construction ensures that the interstitial space 126 between the two shells 122, 124 of the sump 120 remains fluid tight and monitoring of the interstitial space 126 may be performed accurately. The two-part construction also facilitates assembly of the entry fitting 128 and coupling of the entry fitting 128 to the sump 120.

As shown in FIG. 4, in which like reference numerals refer to like features in FIGS. 2 and 2A, the first housing portion 130 is similar to housing 52 described above in reference to entry fitting 50. Moreover, the manner in which first housing portion 130 is mounted to the outer shell 124 of sump 120 is also similar to the mounting of housing 52 to sump 34. Accordingly, the details of first housing portion 130 and the manner in which the first housing portion 130 is coupled to the outer shell 124 of sump 120 will not be repeated here. The second housing portion 132 includes a first end portion 134 adapted to be mounted to the second end portion 56 of first housing portion 130, a second end portion 136 adapted to be located internal to the sump 120, and a passageway 138 extending between the first and second end portions 134, 136 adapted to receive the fluid conduit line 18 therethrough. The first and second housing portions 130, 132 may be formed from a suitable, relatively rigid material such as those identified above in regard to housing 52.

The second housing portion 132 includes a flange 140 projecting outwardly from a terminating end of the first end portion 134 for mating the second housing portion 132 to the inner shell 122 of the sump 120. As noted above, in one embodiment, the second housing portion 132, including flange 140, may be integrally formed from a moldable polymeric material such that the housing portion 132 has a unitary structure. The invention, however, is not so limited as the flange 140 may be coupled to second housing portion 132 as a separate component or element. Moreover, the first end portion 134 of housing 132 is sized and shaped to correspond to the size and shape of the second end portion 56 of first housing portion 130 such that they mate in a relatively tight frictional fit. When the second housing portion 132 is mounted to the first housing portion 130, an outer surface 142 of the flange 140 abuts an inner surface 144 of the inner shell 122 of the sump 120 and operates as a mating surface. To effectuate a seal between the second housing portion 132 and the sump 120, a bonded joint 146 may be formed along at least a portion of the interface between the outer surface 142 of the flange 140 and the inner surface 144 of the inner shell 122 of the sump 120. The bonded joint 146 forms a fluid tight seal between the second housing portion 132 and the inner shell 122 so that no fluid (e.g., fuel, water) may escape from the sump 120 through the interface therebetween on the occasion of a leak and collection of fluid within the sump 120. The adhesives identified above in regard to entry fitting 50 may also be used for bonding the second housing portion 132 to the inner shell 122.

In addition to the above, a bonded joint 148 may also be formed at the interface between the wall portion that defines opening 42 through the inner shell 122 and the outer surface 62 of the first housing portion 130. A bonded joint 152 may further be formed at the interface where the first end portion 134 of the second housing portion 132 engages the second end portion 56 of the first housing portion 130.

Similar to flange 60 described above in regard to tank entry fitting 50, the flange 140 may be profiled or contoured so as to substantially correspond to the shape of the inner surface 144 of the inner shell 122 adjacent opening 42. Thus, in one embodiment, the flange 140 has a generally planar configuration that mates with a generally planar side wall of the sump 120. In an alternative embodiment, however, and as illustrated in FIG. 4, the flange 140 may be configured such that at least the outer surface 142 thereof substantially corresponds to the generally arcuate side wall 44 of the inner shell 122 of the sump 120 (e.g., sump 120 has a generally cylindrical configuration). Contouring the flange 140 provides enhanced bonding between the second housing portion 132 and the sump 120 when the side wall is non-planar. The contouring of the flange 140 may be achieved in the same manner as that described above for flange 60.

The second housing portion 132, or at least an outer surface 154 thereof, has a stepped configuration defining a first bearing surface 156, a second bearing surface 158, and an outwardly directed shoulder 160 therebetween such that the second bearing surface 158 is spaced outwardly relative to the first bearing surface 156, as illustrated in FIG. 4. Each of the bearing surfaces 156, 158 are used to form a fluid tight seal between the second housing portion 132 and the fluid conduit line 18. In this regard, the tank entry fitting 128 further includes two generally flexible coupling members, such as flexible boots 162, 164. The boots 162, 164 may be formed from suitable materials such as those described above in regard to boot 76.

The first boot 162 includes a first end portion 166 adapted to be coupled to the first bearing surface 156 of the second housing portion 132, a second end portion 168 adapted to be coupled to the fluid conduit line 18, and a passageway 170 extending between the first and second end portions 166, 168 and adapted to receive the fluid conduit line 18 therethrough. The first end portion 166 of boot 162 may be sized to approximately correspond to the size of the first bearing surface 156 so as to be received thereon in a slight friction fit. Additionally, the second end portion 168 of boot 162 may be sized to approximately correspond to the size of the fluid conduit line 18. For example, the size of the second end portion 168 may be slightly smaller than fluid conduit line 18 such that the fluid conduit line 18 is tightly received therein. The first and second end portions 166, 168 of the boot 162 may be secured to the first bearing surface 156 of the second housing portion 132 and fluid conduit line 18, respectively, using clamping members, such as band clamps 84.

In a similar manner, the second boot 164 includes a first end portion 172 adapted to be coupled to the second bearing surface 158 of the second housing portion 132, a second end portion 174 adapted to be coupled to the fluid conduit line 18, and a passageway 176 extending between the first and second end portions 172, 174 and adapted to receive the fluid conduit line 18 therethrough. The first end portion 172 of boot 164 may be sized to approximately correspond to the size of the second bearing surface 158 so as to be received thereon in a slight friction fit. Additionally, the second end portion 174 of boot 164 may be sized to approximately correspond to the size of the fluid conduit line 18. For example, the size of the second end portion 174 may be slightly smaller than fluid conduit line 18 such that the fluid conduit line 18 is tightly received therein. The first and second end portions 172, 174 of the boot 164 may be secured to the second bearing surface 156 of the second housing portion 132 and fluid conduit line 18, respectively, using clamping members, such as band clamps 84.

As illustrated in FIG. 4, the first and second boots 162, 164 form redundant seals between the housing 129 of tank entry fitting 128 (e.g., second housing portion 132) and the fluid conduit line 18. It is expected that such a design will meet or exceed any federal, state, or local regulations regarding the handling of materials such as fuel. Moreover, due to the stepped configuration of the second housing portion 132, an interstitial space 178 may be formed between the first and second boots 162, 164. In one embodiment, the second boot 164 includes an access port 180 formed therein that allows the interstitial space 178 to be monitored for any leaks. By way of example, the interstitial space 178 may be pressurized with either positive or negative pressure and monitored, such as by using the access port 180, for a specific period of time in order to determine if a leak exists in the entry fitting 128. Such testing of the interstitial space 178 may be done manually, or alternatively, an automated system may be operatively coupled to the entry fitting 128, such as via access portion 180, so as to monitor the interstitial space 178.

Furthermore, as shown in phantom in FIG. 4, a flexible coupling member may be located external to the sump 120. To this end, the tank entry fitting 128 may include a flexible boot 181 that forms a seal between the first housing portion 130 and the fluid conduit line 18 in a manner similar to that described above in regard to flexible boot 76a shown in FIG. 2A.

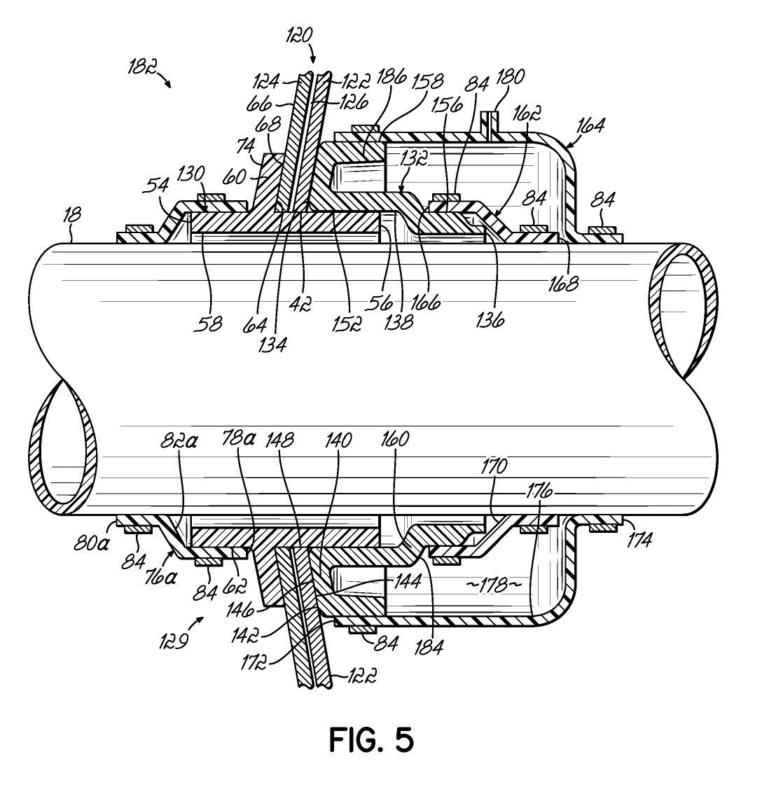

FIG. 5 illustrates another embodiment of a tank entry fitting 182 similar to the tank entry fitting 128 shown in FIG. 4 and also configured to be used with double-walled sumps, but not so limited. As such, like reference numerals refer to like features in FIG. 4 and only the modifications relative to entry fitting 128 will be described in detail. As illustrated in the figure, the embodiment shown in FIG. 5 may be particularly beneficial when relatively large fluid conduit lines pass through the entry fitting. In these cases, there may not be sufficient spacing between the stepped surfaces of the second housing portion 132 so as to provide interstitial space 178. For example, as shown in FIG. 5, the first bearing surface 156 and the housing surface 184 may not be sufficiently spaced so as to accommodate the second boot 164. Therefore, to form a sufficient amount of spacing between the two boots 162, 164, the flange 140 may be L-shaped thereby defining a leg 186 that projects back toward the second end portion 136 of the second housing portion 132. The outer surface of the leg 186 is sufficiently spaced from the first bearing surface 156 so as to effectively operate as the second bearing surface 158. With such a design, the spacing between the boots 162, 164 is sufficient to define interstitial space 178 there between.

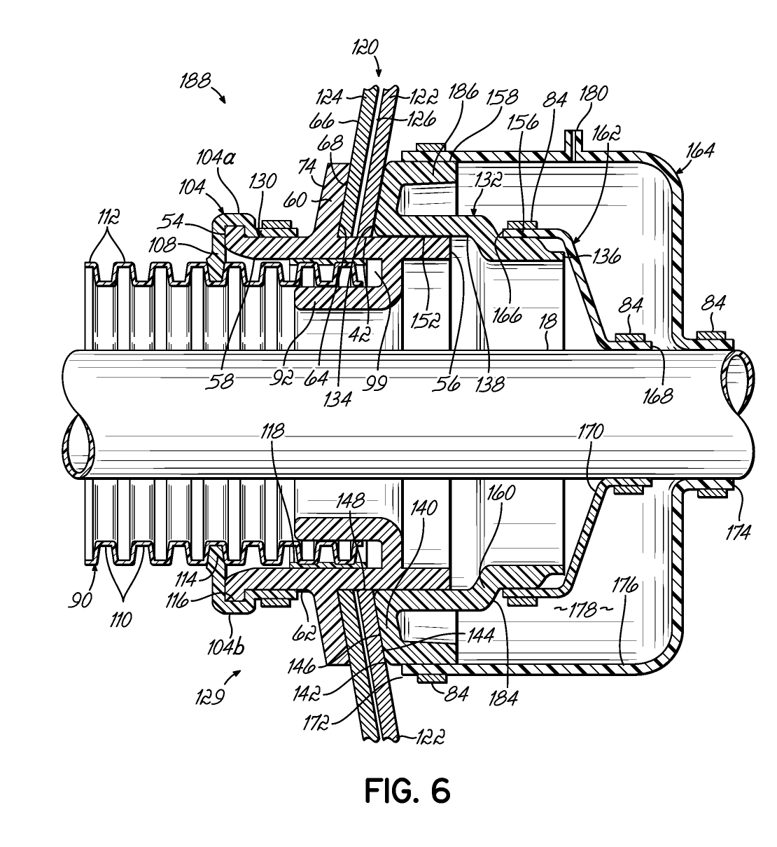

FIG. 6 illustrates another embodiment of a tank entry fitting 188 similar to that shown in FIG. 5, but being configured to be used with access or duct pipe 90, as shown in FIG. 3. Accordingly, like reference numerals in FIG. 6 refer to like features in FIGS. 5 and 3. In particular, the first housing portion 130 of entry fitting 188 has been modified to include the L-shaped flange 92 that forms cavity 99 for receiving the access or duct pipe 90 therein. The access or duct pipe 90 is secured and/or sealed to the first housing portion 130 in the manner described above in regard to that shown in FIG. 3.

While the present invention has been illustrated by a description of various preferred embodiments and while these embodiments have been described in some detail, it is not the intention of the inventor to restrict or in any way limit the scope of the appended claims to such detail. Additional advantages and modifications will readily appear to those skilled in the art. The various features of the invention may be used alone or in numerous combinations depending on the needs and preferences of the user.

What is claimed is:

1. An entry fitting for a fluid conduit line passing through an opening: in a wall, comprising:
a housing adapted to be inserted into the opening in the wall and including a first end portion, a second end portion, and a passageway extending therebetween adapted to receive the fluid conduit line therethrough, the housing further including a rigid portion that defines a mating surface adapted to form a bonded joint with the wall adjacent the opening, the bonded joint adapted to form a fluid tight seal between the housing and the wall; and
a flexible coupling member including a first end portion adapted to be coupled to the housing, a second end portion adapted to be coupled to the fluid conduit line, and a passageway extending therebetween adapted to receive the fluid conduit line therethrough, the flexible coupling member adapted to form a fluid tight seal between the housing and the fluid conduit line.

2. The entry fitting of claim 1, further comprising:
a flange projecting outwardly from the housing, the flange defining the mating surface for forming the bonded joint with the wall.

3. The entry fitting of claim 2, wherein at least the mating surface of the flange includes a non-planar shape.

4. The entry fitting of claim 1, further comprising:
an L-shaped flange projecting inwardly from the housing to define a cavity outboard of the fluid conduit line, the cavity adapted to receive an end portion of an access pipe therein.

5. An entry fitting for a fluid conduit line passing through an opening in a wall, comprising:
a first housing including a first end portion, a second end portion, and a passageway extending therebetween adapted to receive the fluid conduit line therethrough;
a second housing including a first end portion, a second end portion, and a passageway extending therebetween adapted to receive the fluid conduit line therethrough, wherein the first end portion of the second housing is adapted to be coupled to the second end portion of the first housing, and at least one of the first or second housing includes a mating surface adapted to be coupled to the wall adjacent the opening, the mating surface being coupled to the wall so as to form a fluid tight seal between the at least one of the first or second housing and the wall; and
a first flexible coupling member including a first end portion adapted to be coupled to one of the first or second housing, a second end portion adapted to be coupled to the fluid conduit line, and a passageway extending therebetween adapted to receive the fluid conduit line therethrough, the flexible coupling member adapted to form a fluid tight seal between the one of the first or second housing and the fluid conduit line.

6. The entry fitting of claim 5, further comprising:
a flange projecting outwardly from the first housing, the flange defining the mating surface for coupling to the wall.

7. The entry fitting of claim 6, wherein at least the mating surface of the flange including a non-planar shape.

8. The entry fitting of claim 5, further comprising:
a flange projecting outwardly from the second housing, the flange defining the mating surface for coupling to the wall.

9. The entry fitting of claim 8, wherein at least the mating surface of the flange includes a non-planar shape.

10. The entry fitting of claim 5, further comprising:
a second flexible coupling member including a first end portion adapted to be coupled to one of the first or second housing, a second end portion adapted to be coupled to the fluid conduit line, and a passageway extending therebetween adapted to receive the conduit line therethrough.

11. The entry fitting of claim 10, wherein each of the first and second flexible coupling members are coupled to the same housing so as to define an interstitial space therebetween.

12. The entry fitting of claim 11, wherein the second housing includes a stepped configuration that defines a first bearing surface and a second bearing surface spaced outwardly of the first bearing surface, the first flexible coupling member being coupled to the second housing at the first bearing surface, and the second flexible coupling member being coupled to the second housing at the second bearing surface.

13. The entry fitting of claim 12, wherein the second bearing surface is defined by a flange of the second housing.

14. The entry fitting of claim 11, further comprising:
an access port coupled to the second flexible coupling member and in fluid communication with the interstitial space, the access port adapted to be operatively coupled to a device for monitoring a leak.

15. The entry fitting of claim 5, further comprising:
an L-shaped flange projecting inwardly from the first housing to define a cavity outboard of the fluid conduit line, the cavity adapted to receive an end portion of an access pipe therein.

16. The entry fitting of claim 5, wherein the mating surface of the at least one of the first and second housing is rigid.

17. An entry valve for a fluid conduit line passing through an opening in a wall, comprising:
a housing adapted to be inserted into the opening in the wall, the housing including a mating surface adapted to be coupled to the wall adjacent the opening, the mating surface being coupled to the wall so as to form a fluid tight seal between the housing and the wall; and
a pair of redundant flexible coupling members for forming a fluid tight seal between the housing and the fluid conduit line.

18. The entry fitting of claim 17, wherein the pair of redundant coupling members define an interstitial space therebetween.

19. The entry fitting of claim 17, wherein the mating surface of the housing is rigid.

20. An entry fitting for a fluid conduit line passing through an opening in a non-planar wall, comprising:
a housing adapted to be inserted into the opening in the wall, the housing including a mating surface adapted to be coupled to the wall adjacent the opening, the mating surface being coupled to the wall so as to form a fluid tight seal between the housing and the wall; and
a flexible coupling members for forming a fluid tight seal between the housing and the fluid conduit line,
wherein the mating surface has a non-planar shape that corresponds to the non-planar shape of the wall.

21. The entry fitting of claim 21, wherein the mating surface of the housing is rigid.

22. The entry fitting of claim 20, further comprising:
a flange projecting outwardly from the housing, the flange defining the mating surface for forming a bonded joint with the wall.

23. A fuel dispensing system having a fluid conduit line, comprising:
a tank including at least one wall defining an interior and an exterior of the tank, the at least one wall including an opening for receiving the fluid conduit line therethrough; and
an entry fitting, comprising:
a housing inserted into the opening in the at least one wall and including a first end portion, a second end portion, and a passageway extending therebetween that receives the fluid conduit line therethrough, the housing further including a rigid portion that defines a mating surface for forming a bonded joint with the at least one wall adjacent the opening, the bonded joint forming a fluid tight seal between the housing and the wall; and
a first flexible coupling member including a first end portion coupled to the housing, a second end portion coupled to the fluid conduit line, and a passageway extending therebetween that receives the fluid conduit line therethrough, the first flexible coupling member forming a fluid tight seal between the housing and the fluid conduit line.

24. The fuel dispensing system of claim 23, wherein the mating surface is bonded to the at least one wall external to the tank.

25. The fuel dispensing system of claim 23, wherein the flexible coupling member is located in the interior of the tank.

26. The fuel dispensing system of claim 23, further comprising:
a second flexible coupling member including a first end portion coupled to the housing, a second end portion coupled to the fluid conduit line, and a passageway extending therebetween that receives the fluid conduit line therethrough, the second flexible coupling member forming a fluid tight seal between the housing and the fluid conduit line, wherein the first flexible coupling member is located in the interior of the tank and the second flexible coupling member is located in the exterior of the tank.

27. A fuel dispensing system having a fluid conduit line, comprising:
a tank having at least one wall including an inner shell, an outer shell, and an interstitial space therebetween, the at least one wall including an opening for receiving the fluid conduit line therethrough and defining an interior and an exterior of the tank; and
an entry fitting comprising:
a housing adapted to be inserted into the opening in the at least one wall, the housing including a mating surface adapted to be coupled to the wall adjacent the opening, the mating surface being coupled to the at least one wall so as to form a fluid tight seal between the housing and the wall; and
a pair of redundant flexible coupling members for forming a fluid tight seal between the housing and the fluid conduit line.

28. The fuel dispensing system of claim 27, wherein the housing comprises:
a first housing portion including a first end portion, a second end portion, and a passageway extending therebetween that receives the fluid conduit line therethrough, the first housing portion including a mating surface bonded to the outer shell of the tank to form a fluid tight seal between the first housing portion and the at least one wall of the tank;
a second housing portion including a first end portion, a second end portion, and a passageway extending therebetween that receives the fluid conduit line therethrough, wherein the first end portion of the second housing portion is coupled to the second end portion of the first housing portion, the second housing portion including a mating surface bonded to the inner shell of the tank to form a fluid tight seal between the second housing portion and the at least one wall of the tank.

29. The fuel dispensing system of claim 28, further comprising:
a flange projecting outwardly from the first housing portion, the flange defining the mating surface for coupling to the outer shell of the wall.

30. The fuel dispensing system of claim 29, wherein the at least one wall of the tank is non-planar and at least a portion of the flange includes a non-planar shape that corresponds to the non-planar shape of the at least one wall.

31. The fuel dispensing system of claim 28, further comprising:
a flange projecting outwardly from the second housing portion, the flange defining the mating surface for coupling to the inner shell of the wall.

32. The fuel dispensing system of claim 31, wherein the at least one wall of the tank is non-planar and at least a portion of the flange includes a non-planar shape that corresponds to the non-planar shape of the at least one wall.

33. The fuel dispensing system of claim 27, wherein the pair of redundant flexible coupling members defines an interstitial space therebetween.

34. The fuel dispensing system of claim 33, wherein at least a portion of the housing includes a stepped configuration that defines a first bearing surface and a second bearing surface spaced outwardly of the first bearing surface, one of the flexible coupling members being coupled to the housing at the first bearing surface, and the other flexible coupling member being coupled to the housing at the second bearing surface.

35. The fuel dispensing system of claim 34, wherein the second bearing surface is defined by a flange extending from the housing.

36. The fuel dispensing system of claim 27, further comprising:
an L-shaped flange projecting inwardly from the housing to define a cavity outboard of the fluid conduit line, the cavity receiving an end portion of an access pipe therein.
